(19) United States
(12) Patent Application Publication
(10) Pub. No.: US 2010/0226630 A1
(43) Pub. Date: Sep. 9, 2010

(54) APPARATUS FOR HEAT-TREATING SUBSTRATE AND SUBSTRATE MANUFACTURING METHOD

(75) Inventor: Masami Shibagaki, Fuchu-shi (JP)

Correspondence Address: FITZPATRICK CELLA HARPER & SCINTO, 1290 Avenue of the Americas, NEW YORK, NY, 10104-3800, US

(73) Assignee: CANON ANELVA CORPORATION, Kawasaki-shi (JP)

(21) Appl. No.: 12/715,951

(22) Filed: Mar. 2, 2010

(30) Foreign Application Priority Data
Mar. 3, 2009 (JP) 2009-049671

(51) Int. Cl. F27D 11/00; A21B 1/22; F26B 3/30; F25B 29/00

(52) U.S. Cl. 392/416; 219/411; 392/418; 392/422; 165/61

(57) ABSTRACT

In a substrate annealing apparatus, a substrate holder unit including a substrate stage made of carbon with a high emissivity or a material coated with carbon is accommodated in a vacuum chamber to be liftable. Also, a heating unit having a heat radiating surface facing the substrate stage is disposed above the substrate holder unit within the vacuum chamber. The substrate annealing apparatus brings the substrate stage close to the heat radiating surface so that a substrate mounted on the substrate stage can be heated by radiant heat from the heat radiating surface while the heat radiating surface is not in contact with the substrate. The substrate holder unit includes a radiating plate and a reflecting plate made of one of a metal carbide, a metal nitride, and a nickel alloy.

### BACKGROUND OF THE INVENTION

1. Field of the Invention

The present invention relates to an apparatus for heat-treating a substrate for use in, for example, heat-treating of a silicon carbide (SiC) substrate and other substrates and, more particularly, to an apparatus that can uniformly and rapidly heat-treat a substrate in a vacuum and a substrate manufacturing method using the apparatus for heat-treating the substrate.

2. Description of the Related Art

One known an apparatus, for heat-treating a substrate, includes a heating plate, an annular cooling unit, and a substrate holder. The heating plate is disposed in the lower portion of a vacuum chamber, while the cooling unit is disposed in its upper portion. The substrate holder is made of a material with a high thermal conductivity and is inserted between the heating plate and the cooling unit to be liftable (e.g., see Japanese Patent Laid-Open No. 2003-318076). The apparatus for heat-treating the substrate heat-treats a substrate by lowering the substrate holder which mounts the substrate to bring the lower surface of the substrate holder into contact with the heating plate, heating the substrate through the substrate holder, lifting the substrate holder to bring the peripheral edge of the substrate holder into contact with the cooling unit, and cooling the substrate through the substrate holder. Another known an apparatus, for heat-treating a substrate, includes an airtight reaction chamber which heat-treats the substrate at a high temperature and a cooling unit to heat the substrate while it is not in contact with the heating plate (e.g., see Japanese Patent Laid-Open No. 2005-299990).

However, the apparatus and the method described in Japanese Patent Laid-Open No. 2003-318076 heat the substrate through the substrate holder by heat transfer between them. This poses a problem in that heating nonuniformity occurs unless the substrate is uniformly in contact with the substrate holder throughout their entire contact portion. For example, assume that the substrate having undergone implantation, heat-treating, and other processes is warped. In this case, the substrate is in contact with the substrate holder in some portions and is not in contact with it in other portions, and this poses a problem in that the uniformity of the heat-treating characteristics within the plane of the heated substrate deteriorate. Also, because the substrate holder is cooled from its peripheral edge, there is another problem in that not only can the entire substrate holder not be uniformly cooled but also it takes a long time to completely cool the substrate holder up to its central portion.

Although the apparatus disclosed in Japanese Patent Laid-Open No. 2005-299990 heats the substrate to a high temperature by radiant heat, it is desirable to more efficiently heat the substrate in this apparatus. Also, although it prevents heat from the substrate from transferring to the chamber wall even when the substrate is heated to a high temperature, the apparatus disclosed in Japanese Patent Laid-Open No. 2005-299990 requires a large space to accommodate the cooling unit because the wall of the cooling unit cools the substrate, and this requirement of a large space poses a problem in that it increases the size of the apparatus.

### SUMMARY OF THE INVENTION

The present invention has been made in consideration of the above-mentioned problems, and has as its first object to provide an apparatus for heat-treating a substrate and a substrate manufacturing method that can uniformly and rapidly heat-treat a substrate in a vacuum. It is a second object of the present invention to provide an apparatus for heat-treating a substrate and a substrate manufacturing method that can rapidly cool the entire heated substrate. It is a third object of the present invention to provide an apparatus for heat-treating a substrate, the size of which can be decreased and a substrate manufacturing method using said apparatus. The present invention provides an apparatus for heat-treating a substrate and a substrate manufacturing method that solve at least one of the above-mentioned objects.

According to one aspect of the present invention, there is provided an apparatus for heat-treating a substrate, the apparatus comprising:

a substrate holder unit comprising a substrate stage which mounts a substrate and is made of one of carbon and a material coated with carbon;

a heating unit which is disposed above the substrate stage, has a heat radiating surface facing the substrate stage, and heats the substrate mounted on the substrate stage by radiant heat from the heat radiating surface while the heat radiating surface is not in contact with the substrate;

a chamber which accommodates the substrate holder unit and the heating unit; and

a lift device which lifts/lowers at least one of the substrate holder unit and the heating unit so that the substrate stage and the heat radiating surface of the heating unit come close to/separate from each other within the chamber,

wherein the substrate holder unit comprises:

a radiating plate which is disposed on a lower side of the substrate stage with a spacing therebetween, traps heat radiated by a lower surface of the substrate stage, and radiates the trapped heat to the substrate stage; and

a reflecting plate which is disposed on a lower side of said radiating plate with a spacing therebetween, and is made of one of a metal carbide, a metal nitride, a nickel alloy, and a nickel base superalloy.

An apparatus for heat-treating a substrate and a substrate manufacturing method according to the present invention heat a substrate by radiant heat from the heat radiating surface of a heating unit while it is not in contact with the substrate. The heat radiating surface of the heating unit faces and is mounted on a substrate; radiant heat from the heat radiating surface can then uniformly irradiate the substrate irrespective of the presence/absence of warp on the substrate. This makes it possible to uniformly heat the substrate even when it has warped to some extent.

Also, since the substrate stage is made of carbon or a material coated with carbon and at least the surface of the substrate stage is made of carbon with a high emissivity, the substrate also receives radiant heat from the substrate stage heated by radiant heat simultaneously with its heating by the heat radiating surface. In other words, the substrate is primarily heated by radiant heat from the heat radiating surface of the heating unit but secondarily receives radiant heat from the substrate stage, and thus can heat up rapidly. Radiant heat is absorbed during cooling, and this makes it possible to uniformly, rapidly drop the temperature of the entire substrate stage and, in turn, to uniformly, rapidly cool the substrate.

Moreover, since a radiating plate is disposed on the lower side of the substrate stage and a reflecting plate made of one of a metal carbide, a metal nitride, a nickel alloy, and a nickel base superalloy is disposed on the lower side of the radiating plate, it is easy to suppress a drop in temperature of the substrate due to heat radiated by the radiating plate and to rapidly heat the substrate.

Further features of the present invention will become apparent from the following description of exemplary embodiments with reference to the attached drawings.

### BRIEF DESCRIPTION OF THE DRAWINGS

FIG. 1 is a schematic sectional view showing substrate loading or unloading in an apparatus for heat-treating a substrate according to one embodiment of the present invention;

FIG. 2 is a schematic sectional view showing substrate heating;

FIG. 3 is a schematic sectional view showing substrate cooling;

FIG. 4 is an enlarged sectional view of a substrate holder unit and its vicinity in FIG. 1;

FIG. 5 is an enlarged sectional view of the substrate holder unit and its vicinity in FIG. 2;

FIG. 6A is an explanatory view of a substrate stage;

FIG. 6B is an explanatory view of another substrate stage;

FIG. 6C is an explanatory view of still another substrate stage;

FIG. 7 is a sectional view of a p⁺n junction diode fabricated in the third embodiment;

FIG. 8 is a graph showing the heat-treating temperature dependence of the current density vs. voltage characteristics of the p⁺n junction diode fabricated in the third embodiment; and

FIG. 9 is a perspective view showing the internal structure of a lift shaft 12.

### DESCRIPTION OF THE EMBODIMENTS

Embodiments of the present invention will be described in detail below. Note that constituent elements described in these embodiments are merely exemplary ones, and the technical scope of the present invention is determined by the scope of claims and is not limited by the following individual embodiments.

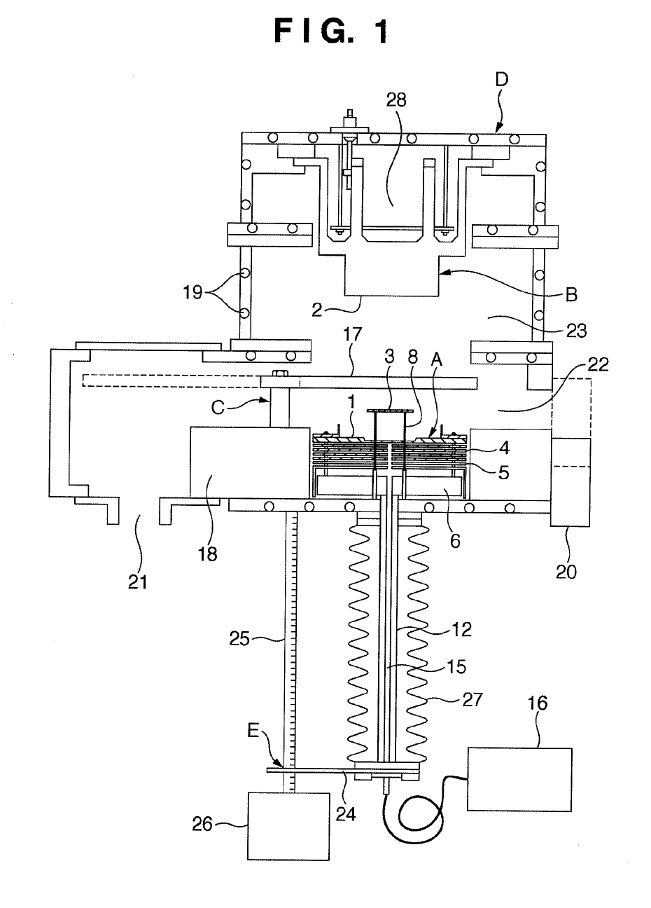

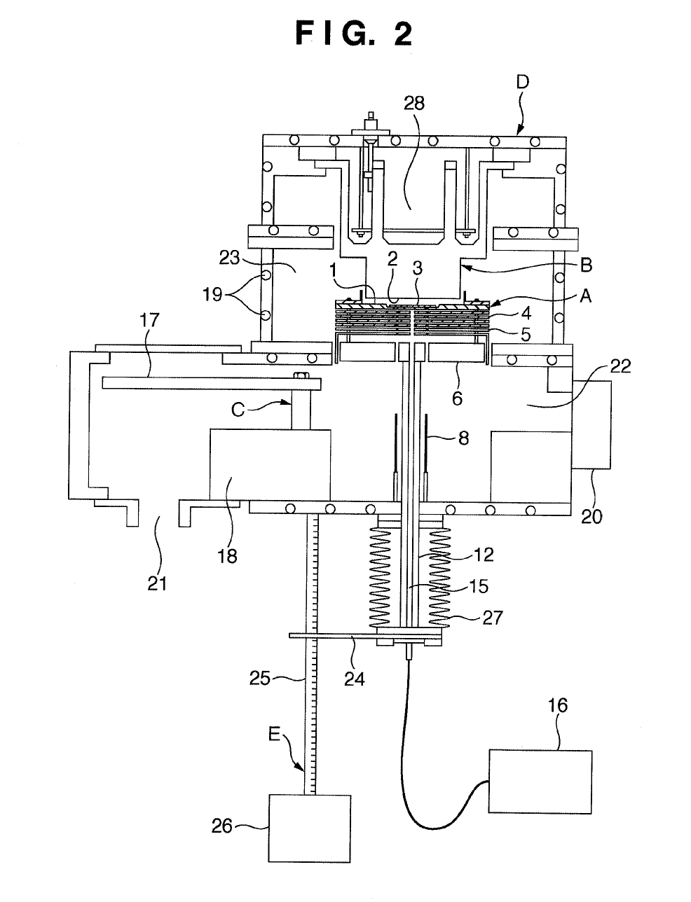

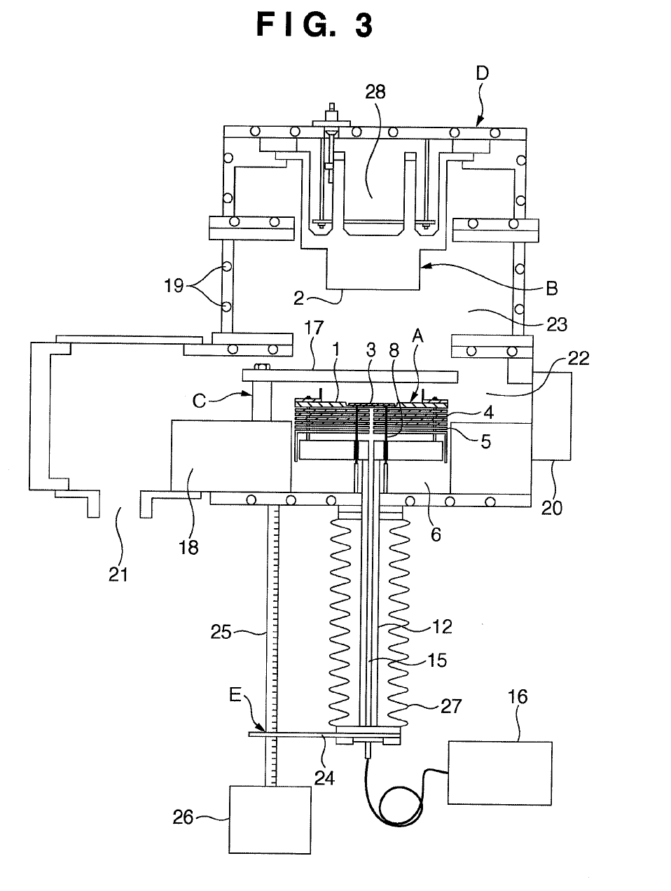

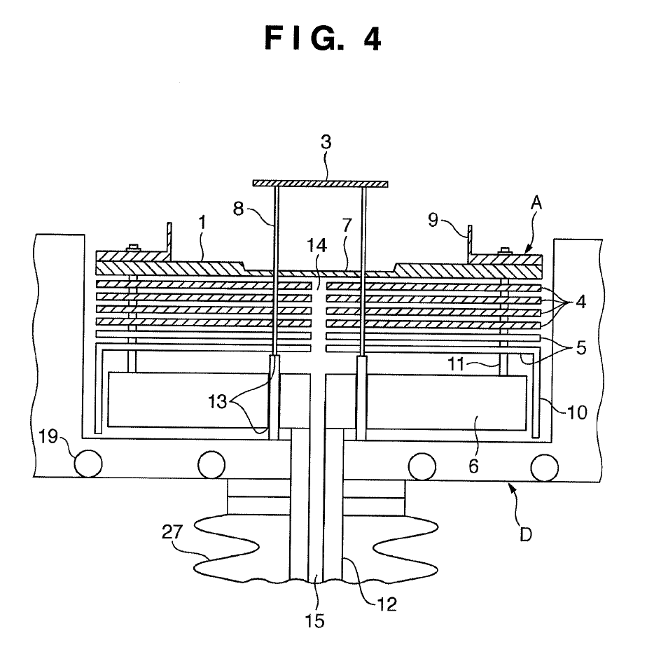

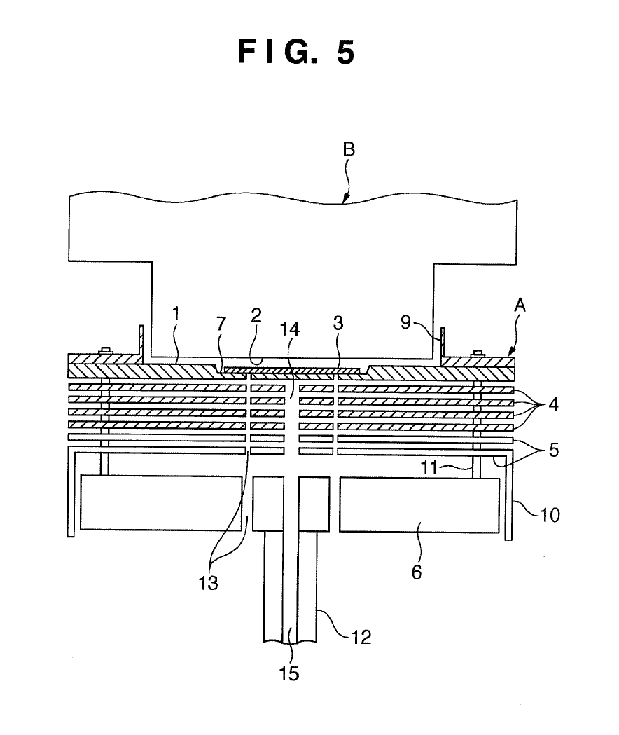

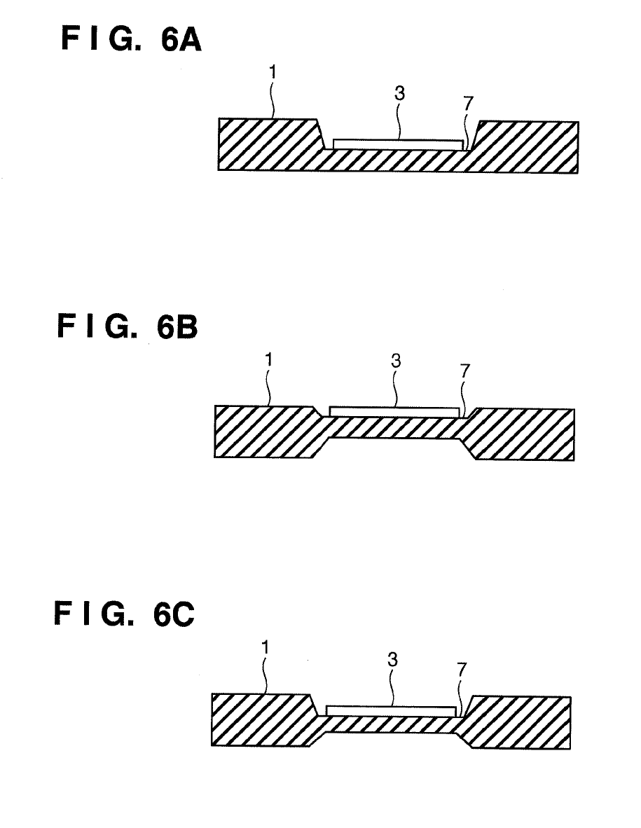

FIG. 1 shows an apparatus for heat-treating a substrate according to one embodiment of the present invention. FIG. 1 is a schematic sectional view showing substrate loading or unloading, FIG. 2 is a schematic sectional view showing substrate heating, and FIG. 3 is a schematic sectional view showing substrate cooling. Also, FIG. 4 is an enlarged sectional view of a substrate holder unit and its vicinity in FIG. 1, FIG. 5 is an enlarged sectional view of the substrate holder unit and its vicinity in FIG. 2, and FIGS. 6A to 6C are explanatory views of substrate stages. Note that the same reference numerals denote the same members or parts in FIGS. 1 to 6A, 6B, and 6C.

As shown in FIGS. 1 to 3, the apparatus for heat-treating the substrate according to this embodiment includes a substrate holder unit A, heating unit B, and shutter device C which are accommodated in a vacuum chamber D.

The substrate holder unit A includes a substrate stage 1 in its top stage. The heating unit B is disposed above the substrate stage 1 and has a heat radiating surface 2 facing the substrate stage 1. The substrate holder unit A can be lifted/lowered by a lift device E, and the substrate stage 1 and the heat radiating surface 2 of the heating unit B can be controlled to come close to/separate from each other by the operation of the lift device E. The heating unit B heats a substrate 3 on the substrate stage 1 by radiant heat from the heat radiating surface 2 while it is not in contact with the substrate 3 when the substrate holder unit A lifts, as shown in FIG. 2, to bring the substrate 3 and the heat radiating surface 2 close to each other.

The substrate holder unit A shown in FIG. 1 is located at the lowering position, whereas the substrate holder unit A shown in FIG. 2 is located at the lifting position. FIG. 4 is an enlarged view of the substrate holder unit A and its vicinity in FIG. 1. FIG. 5 is an enlarged view of the substrate holder unit A and its vicinity in FIG. 2. The substrate holder unit A will be explained mainly with reference to FIGS. 4 and 5, and only the principal members of the substrate holder unit A shown in FIGS. 1 to 3 are denoted by reference numerals.

As shown in FIGS. 4 and 5, the substrate holder unit A includes the substrate stage 1 in its top portion, four radiating plates 4 below the substrate stage 1, two reflecting plates 5 below the radiating plates 4, and a cooling panel 6 in its bottom portion.

The substrate stage 1 mounts the substrate 3 and includes, in its upper central portion, a substrate mounting portion 7 which mounts the substrate 3. The substrate 3 shown in FIG. 4 is lifted and supported by lift pins 8 (to be described later). However, when the substrate stage 1 moves to a position above the lift pins 8 as the substrate holder unit A lifts, the substrate 3 is transferred and placed on the substrate mounting portion 7, as shown in FIG. 5.

The substrate stage 1 is made of a material that has a high emissivity, efficiently absorbs radiant heat, can efficiently radiate the absorbed heat, and can withstand high heat. More specifically, the substrate stage 1 is a plate-like member made of carbon or a material coated with carbon. Examples of the carbon that forms the substrate stage 1 are glassy carbon, graphite, pyrolytic carbon, and carbon fiber reinforced carbon matrix composite (C/C composite). Also, an example of the material coated with carbon is a material obtained by coating ceramics with one or two or more types of the above-mentioned carbon materials.

The substrate stage 1 is preferably thin so as to suppress its heat capacity and shorten its cooling time. Although the thickness of the substrate stage 1 changes depending on its constituent material and the amount of groove of the substrate mounting portion 7 (to be described next), it is preferably 2 to 7 mm from the viewpoint of achieving both a given strength and a short cooling time.

The substrate mounting portion 7 is preferably formed at the central portion of the substrate stage 1 as a groove; the peripheral portion of the substrate stage 1, that surrounds the substrate mounting portion 7, has a thickness larger than that of the substrate mounting portion 7. This makes it possible to prevent radiant heat from the heat radiating surface 2 from dissipating to the outside of the substrate 3 and to increase the heat capacity of the outer peripheral portion of the substrate stage 1, that surrounds the substrate mounting portion 7, thus suppressing heat dissipation from the outer peripheral portion of the substrate 3. This, in turn, makes it possible to assist heating of the peripheral portion of the substrate 3, which is prone to receive insufficient heat, so as to more uniformly heat the entire substrate 3. FIGS. 6A to 6C show modes in which the substrate mounting portion 7 is formed in the substrate stage 1 as a groove; the peripheral portion of the substrate stage 1, that surrounds the substrate mounting portion 7, has a thickness larger than that of the substrate mounting portion 7. FIG. 6A is a view showing a mode in which a relatively deep groove is formed in only the upper surface of the substrate stage 1 as the substrate mounting portion 7. FIG. 6B is a view showing a mode in which grooves are formed in both the upper and lower surfaces of the substrate stage 1 at corresponding positions as the substrate mounting portion 7 and the groove on the lower surface side is deeper than the one on the upper surface side. FIG. 6C is a view showing a mode in which the depths of the upper and lower grooves are reversed from those in FIG. 6B.

An annular wall portion 9 which receives the heat radiating surface 2 of the heating unit B on its inner side when the substrate stage 1 and the heat radiating surface 2 of the heating unit B come close to each other, as shown in FIG. 5, projects around the substrate mounting portion 7 in the substrate stage 1. The annular wall portion 9 is preferably made of the same carbon or the same material coated with carbon as in the substrate stage 1. Alternatively, the annular wall portion 9 can be made of a metal carbide, such as tantalum carbide (TaC), which enhances the heat insulating characteristics against the outer peripheral portion and has a high-temperature resistance and a low emissivity. The use of the annular wall portion 9 makes it possible to prevent radiant heat from the heat radiating surface 2 of the heating unit B from escaping to the periphery and, in turn, to improve the efficiency of heating the substrate 3 by the heat radiating surface 2.

The four radiating plates 4 and two reflecting plates 5 are inserted between the substrate stage 1 and the cooling panel 6 with a spacing between them.

The radiating plates 4 are plate-like members made of carbon or a material coated with carbon, like the substrate stage 1, and are disposed below the substrate stage 1 with a spacing between them. The radiating plates 4 face the lower surface of the substrate stage 1, so they trap heat radiated by the lower surface of the substrate stage 1 and radiate the trapped heat to the substrate stage 1 during heating of the substrate 3. This makes it possible to suppress a drop in temperature of the substrate stage 1 attributed to its heat radiation, thus facilitating rapid heating.

The radiating plate 4 is preferably used in order to efficiently raise the temperature of the substrate stage 1. When radiating plates 4 are used, one or a plural number of them other than four as illustrated in FIGS. 1 to 3 may be adopted. The substrate holder unit A preferably includes a plurality of radiating plates 4 because this makes it possible to attain a rapid rise in temperature, as described above, even when the radiating plates 4 are relatively thin. This also makes it possible to shorten the cooling time by suppressing the heat capacities of the radiating plates 4 as relatively thin radiating plates 4 can be used in that case. Although the thicknesses of the radiating plates 4 change depending on the constituent material and number of them, they are preferably 1 to 3 mm from the viewpoint of achieving both a rapid rise in temperature during heating and a short cooling time.

The two reflecting plates 5 are disposed on the lower side of the radiating plates 4 (if there is one radiating plate 4, the lower side of the radiating plate 4; and if there are a plurality of radiating plates 4, the lower side of the lowermost radiating plate 4) with a spacing between them. The reflecting plates 5 are made of one of a metal carbide, a metal nitride, a nickel alloy, and a nickel base superalloy, and at least their surfaces (upper surfaces) on the side of the radiating plates 4 have undergone a mirror finish. The reflecting plates 5 reflect heat radiated by the substrate stage 1 and radiating plates 4. The metal carbide can be a carbide of a refractory metal, with a melting point of 2,500° C. or more, such as tantalum, tungsten, or molybdenum, and is preferably, for example, tantalum carbide (TaC), tungsten carbide (WC), or molybdenum carbide (MoC). Of these carbides, tantalum carbide (TaC) is especially preferable because it radiates less heat and has a high melting point. The metal nitride can be, for example, titanium nitride, depending on the service temperature conditions. The nickel base superalloy means a heat-resistant alloy which contains nickel as its major component and additionally contains, for example, cobalt, chromium, molybdenum, tungsten, aluminum, titanium, tantalum, hafnium, rhenium, ruthenium, niobium, carbon, boron, zirconium.

When the substrate holder unit A includes one or a plurality of reflecting plates 5 on the lower side of the radiating plates 4, this facilitates suppression of a drop in temperature attributed to heat radiation by the substrate stage 1 and radiating plates 4 and, in turn, facilitates rapid heating. Moreover, the reflecting plates 5 are preferably used because this makes it possible to block heat radiation by the substrate stage 1 and radiating plates 4 and, in turn, to prevent a rise in temperature of the chamber.

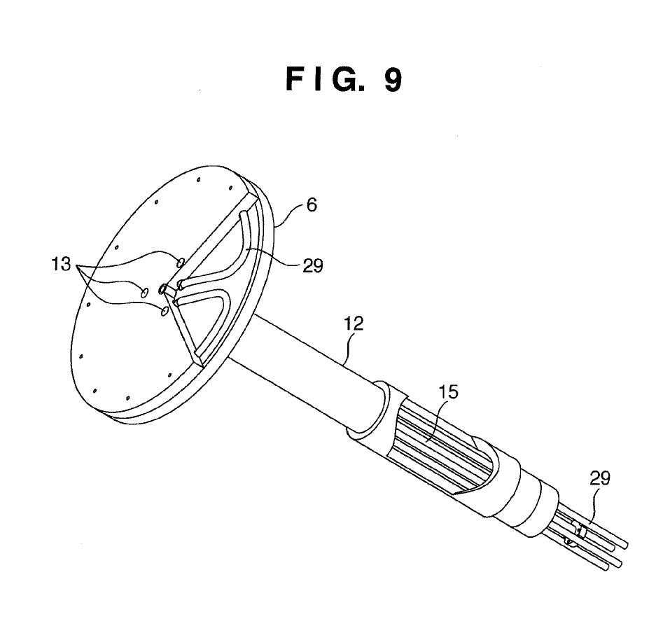

When the above-mentioned reflecting plates 5 are used, the cooling panel 6 can be disposed on the lower side of the reflecting plates 5 (if there is one reflecting plate 5, the lower side of the reflecting plate 5; and if there are a plurality of reflecting plates 5, the lower side of the lowermost reflecting plate 5) with a spacing between them. The cooling panel 6 is a panel body cooled by a cooling means such as a water cooling mechanism. Placing the cooling panel 6 to face the lower surfaces of the substrate stage 1, radiating plates 4, and reflecting plates 5 makes it possible to uniformly, rapidly cool these members positioned above the cooling panel 6 during cooling of the substrate 3. FIG. 9 is a perspective view showing the internal structure of a lift shaft 12 connected to the cooling panel 6. The lift shaft 12 includes a temperature measurement hole 15 to be connected to a temperature measurement device 16. The lift shaft 12 also includes a plurality of refrigerant circulation channels 29 which supply a refrigerant to the cooling means of the cooling panel 6 and recover the refrigerant from the cooling means.

As will be described later, when the cooling panel 6 cools the substrate holder unit A during heating of the substrate 3 shown in FIG. 5, it is possible to control the temperature of the substrate holder unit A constant. This is advantageous in improving the reproducibility of the temperature of the substrate stage 1 attributed to radiant heating.

When the cooling panel 6 is used, it is preferable to use the reflecting plates 5 so as not to disturb heating of the substrate 3 and to suppress heat absorption by forming the outer wall of the cooling panel 6 from, for example, stainless steel or an aluminum alloy having undergone a mirror finish, as described above.

When the cooling panel 6 is used, a skirt portion 10 preferably extends around the peripheral portion of the cooling panel 6 from the peripheral edge of the lowermost reflecting plate 5 (if there is one reflecting plate 5, the reflecting plate 5). The use of the skirt portion 10 makes it possible to suppress heat absorption by the peripheral side surface of the cooling panel 6 to prevent its adverse influence exerted on heating of the substrate 3.

The substrate stage 1, radiating plates 4, and reflecting plates 5 are supported on the cooling panel 6 by connecting screws 11 through heat-resistant/heat-insulating materials such as alumina ceramics, zirconium oxide ceramics, boron nitride ceramics (BN), pyrolytic boron nitride (PBN), pyrolytic carbon, or tantalum carbide (TaC). Also, the cooling panel 6 is connected to the leading end of the lift shaft 12 of the lift device E (see FIG. 1) (see FIG. 9). As will be described later, the lift device E vertically lifts/lowers the cooling panel 6 in the axial direction of the lift shaft 12. Hence, the substrate holder unit A disposed above the cooling panel 6 lifts/lowers as the cooling panel 6 vertically moves.

A plurality of through holes 13 are formed in the substrate holder unit A to run through the substrate stage 1, radiating plates 4, reflecting plates 5, and cooling panel 6 that constitute the substrate holder unit A. The lift pin through holes 13 are formed at positions which pass through especially the substrate mounting portion 7 in the substrate stage 1. The plurality of lift pins 8 stand upright in the bottom portion of the vacuum chamber D in correspondence with the positions of the lift pin through holes 13.

Referring to FIG. 4, the plurality of lift pins 8 which stand upright in the bottom portion of the vacuum chamber D extend above the substrate stage 1 through the lift pin through holes 13. The number and positions of lift pins 8 are determined such that the substrate 3 on the substrate mounting portion 7 can be lifted and supported at the leading ends of the lift pins 8. When the substrate stage 1 moves to a position above the lift pins 8 as the substrate holder unit A lifts in the state shown in FIG. 4, the substrate 3 is transferred onto the substrate mounting portion 7. Also, when the lift pins 8 extend above the substrate stage 1 through the lift pin through holes 13 as the substrate holder unit A lowers while the substrate 3 is mounted on the substrate mounting portion 7, the substrate 3 on the substrate mounting portion 7 is lifted and supported at the leading ends of the lift pins 8 and the substrate holder unit A returns to the state shown in FIG. 4. The lift pins are preferably made of a material which has a high emissivity, efficiently absorbs radiant heat, and can withstand high heat, like the substrate stage. More specifically, the lift pins are preferably formed from carbon or a material coated with carbon. The carbon is preferably pyrolytic carbon.

A measurement hole 14 is formed immediately under the central portion of the substrate mounting portion 7 in the substrate stage 1 to run through the radiating plates 4, reflecting plates 5, and cooling panel 6. The measurement hole 14 forms a continuous hole with the measurement hole 15 formed at the center of the lift shaft 12. The measurement holes 14 and 15 are used to measure heat, radiated by the substrate stage 1, through a thermal infrared transmission window made of quartz by the temperature measurement device 16 shown in FIG. 1. The temperature measurement device 16 can be a radiation thermometer.

The heating unit B includes the heat radiating surface 2 and a heater 28 for heating the heat radiating surface 2. The heater 28 can be of, for example, the electron bombardment heating scheme, high-frequency induction heating scheme, or resistance heating scheme. The heat radiating surface 2 is a heat-resistant black surface and can be obtained by carbon coating using, for example, glassy carbon, pyrolytic carbon, or amorphous carbon. When the heat radiating surface 2 is such a surface coated with carbon, it is possible to suppress both degassing in a vacuum and particle generation.

The shutter device C can insert/retract a shutter 17 into/from the space between the substrate stage 1 and the heat radiating surface 2 of the heating unit B when the substrate stage 1 and the heat radiating surface 2 are separated from each other as the substrate holder unit A lowers, as shown in FIGS. 1 to 3. The shutter device C includes a shutter driving device 18 for inserting/retracting the shutter 17 into/from that space.

The shutter 17 functions as a thermal barrier wall. As shown in FIGS. 1 and 3, when the substrate stage 1 and the heat radiating surface 2 are separated from each other as the substrate holder unit A lowers, the shutter 17 is inserted into the space between the substrate stage 1 and the heat radiating surface 2 to prevent heat from being radiated from the heat radiating surface 2 to the substrate stage 1. Also, when the substrate holder unit A lifts, the shutter 17 is rotationally driven by the shutter driving device 18, thereby being retracted from the space between the substrate stage 1 and the heat radiating surface 2 to the position shown in FIG. 2 (this position is indicated by a broken line in FIG. 1). The shutter 17 is maintained at the retraction position until the substrate holder unit A lowers again to the position where the shutter 17 does not collide with the substrate holder unit A after the substrate holder unit A lifts.

The shutter device C preferably includes a cooling means of the shutter 17, such as a water cooling mechanism, so as to accelerate cooling of the substrate stage 1 and the substrate 3 on it when the shutter 17 is inserted. When a cooling means performs the cooling, the shutter 17 can be made of stainless steel or an aluminum alloy. Also, the surface (upper surface) of the shutter 17, which faces the heat radiating surface 2 of the heating unit B when the shutter 17 is inserted, preferably serves as a reflecting surface having undergone a mirror finish to facilitate shielding of heat from the heat radiating surface 2. Alternatively, to enhance the heat resistance of the shutter 17, a cover made of a refractory metal such as molybdenum or a refractory metal carbide such as tantalum carbide (TaC) can be additionally provided on the surface of the shutter 17 on the side of the heat radiating surface 2 of the heating unit B. The surface (lower surface) of the shutter 17, which faces the substrate stage 1 of the substrate holder unit A when the shutter 17 is inserted, preferably serves as a heat absorbing surface that is a heat-resistant black surface so as to rapidly cool the substrate stage 1 and the substrate 3 on it. The heat absorbing surface can be obtained not only by forming a wall surface from a black material such as black anodized aluminum but also by carbon coating using, for example, glassy carbon, pyrolytic carbon, or amorphous carbon.

To actively cool the substrate stage 1 and the substrate 3 on it by the shutter 17, setting which allows arbitrary selection of the position to which the substrate holder unit A is lowered is preferably performed in advance. First, after heat-treating is completed, the heating unit B is powered off or the heat radiating surface 2 of the heating unit B and the substrate stage 1 are separated from each other, and the processing substrate is gradually cooled to prevent its thermal deformation attributed to rapid cooling. At this time, depending on the heat-treating temperature and the substrate material to be processed, gradual cooling can also be performed by gradually increasing the distance between the heat radiating surface 2 of the heating unit B and the substrate stage 1. Next, the substrate stage 1 is lowered to a position below the lower surface of the shutter 17 and the shutter 17 is closed to cool the processing substrate. At this time, to reduce any thermal shock, it is possible to transfer the substrate 3 to the lift pins 8 after the substrate 3 is cooled while it is not in contact with the lift pins 8 and lower the substrate holder unit A to the transport position. The loading/unloading position is the position of the substrate holder unit A shown in FIG. 1.

The cooling means of the shutter 17 may be omitted, depending on the heating temperature region of the substrate 3. In this case, the shutter 17 is preferably made of a refractory metal such as molybdenum or tungsten or a refractory metal carbide such as tantalum carbide (TaC). Even when no cooling means is adopted, it is preferable that the surface, which faces the heat radiating surface 2, of the shutter 17 serves as a reflecting surface and the surface, which faces the substrate stage 1, of the shutter 17 serves as a heat absorbing surface in order to shield heat from the heat radiating surface 2 and accelerate cooling of the substrate stage 1 and the substrate 3 on it.

The vacuum chamber D is a housing made of, for example, an aluminum alloy and includes a water cooling channel 19 of a water cooling mechanism in its wall. The vacuum chamber D also includes a slit valve 20 which opens/closes in loading/unloading the substrate 3, and an exhaust port 21 connected to an exhaust system to evacuate the interior of the vacuum chamber D into a vacuum ambient. Supplying cooling water into the water cooling channel 19 makes it possible to prevent an excessive rise in temperature of the housing of the vacuum chamber D.

The vacuum chamber D includes a first room 22 on the lower side and a second room 23 which is located above and communicates with the first room 22. The heating unit B is placed in the second room 23, positioned above the first room 22, such that the heat radiating surface 2 faces down. The substrate holder unit A can lift/lower between the first room 22 and the second room 23, and brings the substrate stage 1 and the heat radiating surface 2 of the heating unit B close to each other while the first room 22 and the second room 23 are partitioned with the cooling panel 6, as shown in FIG. 2, upon being lifted. When the substrate 3 is heated in this way, heat generated in the second room 23 is less prone to leak to the first room 22 below the second room 23. This allows more rapid cooling upon lowering the substrate holder unit A to the first room 22 after heating. The inner surface of the vacuum chamber D, especially the inner surface of the second room 23, has preferably undergone a mirror finish so as to improve the heating efficiency.

The lift device E includes the lift shaft 12, a lift arm 24, and a ball screw 25. The lift shaft 12 has its upper end connected to the cooling panel 6 of the substrate holder unit A. The lift arm 24 is attached to the lower end of the lift shaft 12. The ball screw 25 threadably engages with the lift arm 24. The lift device E also includes a rotation driving device 26 and bellows cover 27. The rotation driving device 26 can rotate the ball screw 25 in both the forward and reverse directions. The bellows cover 27 covers a slide portion between the lift shaft 12 and the vacuum chamber D to increase the airtightness in the vacuum chamber D, and stretches/contracts as the lift shaft 12 vertically moves. The lift device E rotates the ball screw 25 in the forward or reverse direction by the rotation driving device 26 to lift or lower the lift arm 24 which is threadably engaging with the ball screw 25, and vertically slides the lift shaft 12 along with the lifting or lowering, thereby lifting or lowering the substrate holder unit A.

The foregoing description is concerned with a vacuum chamber. If a chamber other than a vacuum chamber is used, it needs to be filled with an inert gas such as argon gas.

The driving state of the above-mentioned apparatus for heat-treating the substrate will be explained next.

First, as shown in FIG. 1, the slit valve 20 is opened to load a substrate 3 into the vacuum chamber D. As will be described hereinafter, a substrate 3 can be loaded by, for example, carrying the substrate 3 into the vacuum chamber D by a robot, and placing and supporting the substrate 3 on the lift pins 8, as shown in FIGS. 1 and 4.

The slit valve 20 of the vacuum chamber D is normally connected to a load/unload lock chamber (not shown) via a transfer chamber (not shown) which accommodates a robot. A substrate 3 is set in the load/unload lock chamber first. After rough evacuation in the load/unload lock chamber, this chamber is opened to the transfer chamber and is further evacuated. Then, the slit valve 20 is opened, and the robot (not shown) in the transfer chamber picks up the substrate 3 from the load/unload lock chamber and places it on the lift pins 8.

At this time, the distal end of the robot arm is preferably made of carbon, refractory metal or ceramics so as to withstand high temperatures. Also, to prevent the robot arm from being blown by radiant heat from the heat radiating surface 2 of the heating unit B, the shutter 17 is preferably inserted into the space between the substrate stage 1 and the heat radiating surface 2.

After the robot arm escapes, the slit valve 20 closes, and the vacuum chamber D is set as an independent vacuum chamber, the shutter 17 retracts and the substrate holder unit A lifts. After the substrate 3 is picked up by the substrate mounting portion 7 in the substrate stage 1, the substrate holder unit A is further lifted to bring the substrate stage 1 of the substrate holder unit A and the heat radiating surface 2 of the heating unit B close to each other, as shown in FIGS. 2 and 5. At this time, it is necessary that at least the substrate 3 is not in contact with the heat radiating surface 2. Although the substrate stage 1 can be in contact with the heat radiating surface 2, both the substrate stage 1 and the substrate 3 on it are preferably not in contact with the heat radiating surface 2. The interval between the heat radiating surface 2 and the substrate 3 is preferably 1 to 25 mm, depending on, for example, the sizes of the heat radiating surface 2 and substrate 3, the heating temperature, and the heating power of the heating unit B.

The temperature rise time can be shortened by keeping the heating unit B heating at 1,200° C. while the substrate 3 is transported after the shutter 17 is closed. The power of the heater 28 of the heating unit B is raised to heat the substrate 3 at a high temperature by radiant heat from the heat radiating surface 2. When the heating temperature is, for example, 1,650° C., the heating continues until the temperature of the substrate stage 1 measured by the temperature measurement device 16 reaches 1,650° C. After 1,650° C. is reached, this temperature is maintained for a predetermined heat-treating time (e.g., about 1 min).

After the above-mentioned heat-treating time elapses, the heater 28 of the heating unit B is turned off and natural cooling starts. At the same time, the substrate holder unit A is lowered to the above-mentioned preliminary cooling position (e.g., the distance between the heat radiating surface 2 and the substrate holder unit A is 50 mm), so the temperature of the substrate stage 1 measured by the temperature measurement device 16 drops to 1,200° C. After that, to cool the substrate stage 1 without bringing the substrate 3 into contact with the lift pins 8, the distance between the heat radiating surface 2 and the substrate holder unit A is decreased to 168 mm, and the shutter 17 is inserted into the space between the heating unit B and the heat radiating surface 2, thereby accelerating the cooling. The substrate stage 1 continues to be cooled until its temperature measured by the temperature measurement device 16 reaches 800° C. The substrate holder unit A is lowered to the above-mentioned loading/unloading position. While the substrate holder unit A is lowered from the cooling position to the loading/unloading position, the substrate 3 is transferred onto the lift pins 8 and becomes easy to pick up. After the substrate holder unit A lowers to the loading/unloading position, the slit valve 20 is opened and the substrate 3 is picked up by the robot in the transfer chamber (not shown).

Although the substrate holder unit A can lift/lower in the above-described example, both the substrate holder unit A and the heating unit B or only the heating unit B can lift/lower instead. The heating unit B can be lifted/lowered by turning the lift device E in this embodiment on the vacuum chamber D upside down and connecting the lift shaft 12 to the heating unit B.

If both the substrate holder unit A and the heating unit B can lift/lower, their distance during cooling can be set large by vertically extending the second room 23 in this embodiment. In other words, the cooling efficiency can be improved by lowering the substrate holder unit A and lifting the heating unit B after heating at the position described with reference to FIG. 2, and increasing the distance between the heat radiating surface 2 and the substrate stage 1 and the substrate 3 on it during cooling of the substrate 3. If only the heating unit B can lift/lower, the basic benefits in the above-described example can be obtained although there are disadvantages: it is necessary to omit the lift pins 8 or provide a mechanism for vertically moving them; and cooling at the above-mentioned cooling position is hard.

The apparatus for heat-treating the substrate according to the present invention is best suited to anneal a substrate 3 having a well region (implanted region) on its surface. An example of such a substrate 3 is the one obtained by depositing, for example, SiO₂ on a bulk SiC substrate having undergone sacrificial oxidation and a hydrofluoric acid treatment, fabricating a mask by lithography and dry etching, and implanting aluminum ions into the substrate as an impurity by, for example, an ion implantation device. A well region can be selectively formed in the SiC substrate. Aluminum ions can be implanted by exciting, for example, TMA (TetraMethylAluminum) as the source of aluminum ions using a plasma and extracting the aluminum ions to be implanted by an extraction electrode and an analyzer tube. Aluminum ions can also be implanted by exciting aluminum as the source of aluminum ions using a plasma and extracting the aluminum ions to be implanted by an extraction electrode and an analyzer tube.

Using the apparatus for heat-treating the substrate according to the present invention, a substrate 3 having an implant region on its surface is mounted on the substrate stage 1 such that the surface of the substrate 3 on the side of the implantation region faces the heat radiating surface 2 of the heating unit B, and the substrate 3 is heat-treated by heating using radiant heat from the heat radiating surface 2. This allows heat-treating with very little surface roughness. The implantation region means herein a region formed by impurity implantation in the process of forming, for example, a transistor, a contact, or a channel.

### Example 1

A 10-μm thick p-type SiC epitaxial layer was formed on a 4H—SiC(0001) substrate by CVD, and nitrogen ions were implanted into the epitaxial layer by the multistep method so as to form a box profile at room temperature, an implantation concentration of 4×10¹⁹ ions/cm³, and a depth of 220 nm. The thus obtained substrate sample was heat-treated using an apparatus for heat-treating a substrate according to the present invention, as shown in FIGS. 1 to 5. Note that one reflecting plate made of tantalum carbide (TaC) was employed as a reflecting plate 5, and four radiating plates made of pyrolytic carbon were employed as radiating plates 4.

The substrate sample was mounted on a substrate stage 1 such that its surface into which nitrogen ions were implanted faced up (the side of a heat radiating surface 2 of a heating unit B). The substrate sample was heat-treated by heating for 1 min in a reduced pressure atmosphere of 10⁻⁴ Pa by setting the interval between the heat radiating surface 2 of the heating unit B and the surface, into which nitrogen ions were implanted, of the substrate sample to 5 mm. The temperature of the substrate stage 1 was set to 1,650° C. and that of the heat radiating surface 2 was set to 1,670° C. Note that a temperature measurement device 16 can measure the temperature of the substrate stage 1.

Table 1 shows the sheet resistance value of the heat-treated surface into which nitrogen ions were implanted, and the RMS value indicating the surface roughness measured using an AFM.

### Comparative Example 1

A substrate sample identical to the one used in Example 1 was mounted on a conventional plate-like substrate holder including a heating means, such that the surface, into which nitrogen ions were implanted, of the substrate sample faced up (the side opposite to the substrate holder), was covered with a carbon cap (cover), and was heat-treated in the same way as in Example 1 by heating for 1 min under the same reduced pressure as in Example 1. The temperature of the substrate holder during heating was set to 1,900° C. Note that the temperature of the cap was 1,720° C.

Table 1 shows the sheet resistance value of the heat-treated surface into which nitrogen ions were implanted, and the RMS value indicating the surface roughness measured in the tapping mode using an AFM (Measurement Range: 4 μm×4 μm).

TABLE 1

| | Sheet Resistance | Surface Roughness |
|---|---|---|
| | (Ω/sq) | (RMS Value: nm) |
| Example 1 | 526 | 0.68 |
| Comparative Example 1 | 530 | 0.92 |

As can be seen from Table 1, both the sheet resistance value and the surface roughness in heat-treating using the apparatus for heat-treating the substrate according to the present invention are favorably lower than those in heat-treating using a conventional general apparatus. Table 1 also reveals that the apparatus for heat-treating the substrate according to the present invention can obtain nearly the same sheet resistance even when the temperature of the heat radiating surface is set lower than the heating temperature of a substrate holder in a conventional general apparatus which heats the substrate holder. Table 1 moreover reveals that the sheet resistance value attributed to activation heat-treating is determined not by the apparatus heating temperature but by the temperature of the surface facing the surface, into which ions are implanted, of the substrate.

### Example 2

A 10-μm thick n-type SiC epitaxial layer was formed on a 4H—SiC(0001) substrate by CVD, and aluminum ions were implanted into the epitaxial layer by the multistep method so as to form a box profile at 500° C., an implantation concentration of 2×10¹⁸ ions/cm³, and a depth of 800 nm. The thus obtained 3-inch SiC substrate was employed as a substrate sample and heat-treated using an apparatus for heat-treating a substrate according to the present invention, as shown in FIGS. 1 to 5.

The substrate sample was mounted on a substrate stage 1 such that its surface into which aluminum ions were implanted faced up (the side of a heat radiating surface 2 of a heating unit B). The substrate sample was heat-treated by heating for 1 min in a reduced pressure atmosphere of 10⁻⁴ Pa by setting the interval between the heat radiating surface 2 of the heating unit B and the surface, into which aluminum ions were implanted, of the substrate sample to 5 mm. The temperature of the substrate stage 1 was set to 1,700° C. and that of the heat radiating surface 2 during heating was set to 1,810° C.

After the heat-treating, the carrier activation rate was evaluated using the CV method. The carrier activation rate was as ideally high as 95%, and the variation in activation rate within the plane of the substrate sample was as very low as 5% or less.

The RMS value measured in the tapping mode using an AFM (Measurement Range: 4 μm×4 μm) was 0.6 nm, and this means that the RMS value was favorably less than 1 nm and the substrate sample was flat free from any step bunching. No damage such as a crack or a slip in crystallinity due to a thermal shock was observed in the heat-treated substrate sample. The processing time, including the substrate loading, heating, cooling, and unloading times, per substrate was 12 min. Hence, the throughput was about 10 times as high as that of a conventional apparatus which does not use robot transportation.

### Example 3

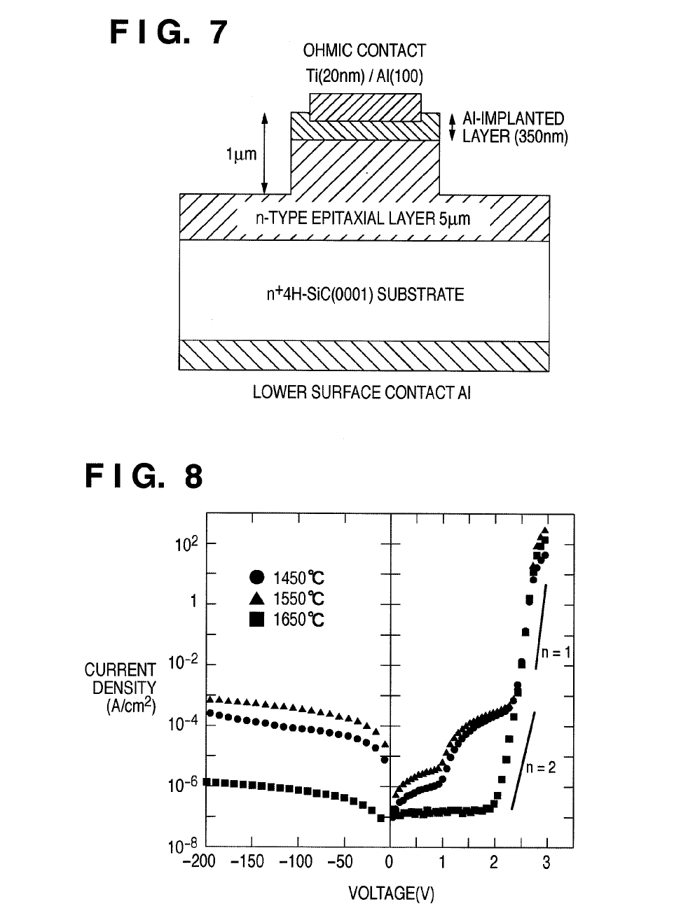

A substrate was heat-treated using a substrate annealing apparatus according to the present invention, as shown in FIGS. 1 to 5, to fabricate an ion-implanted p⁺n junction diode having a cross-sectional shape as shown in FIG. 7.

A 5-μm thick n-type epitaxial layer was formed on an n⁺-type 4H—SiC(0001) substrate with an off-angle of 4°, and underwent sacrificial oxidation and a hydrofluoric acid treatment. After that, an ion implantation device implanted nitrogen into the substrate by the multistep method within the implantation energy range of 30 keV to 170 keV so as to obtain an implantation concentration of 3×10²⁰/cm³ at an implantation temperature of 500° C. and a depth of 350 nm. The thus obtained SiC substrate was employed as a substrate sample and heat-treated using an apparatus for heat-treating a substrate according to the present invention, as shown in FIGS. 1 to 5.

The substrate sample was mounted on a substrate stage 1 such that its surface into which nitrogen ions were implanted faced up (the side of a heat radiating surface 2 of a heating unit B). The substrate sample was heat-treated by heating for 1 min in a reduced pressure atmosphere of 10⁻⁴ Pa by setting the interval between the heat radiating surface 2 of the heating unit B and the surface, into which nitrogen ions were implanted, of the substrate sample to 5 mm. The temperature of the substrate stage 1 was set to 1,450° C., 1,550° C., and 1,650° C. and that of the heat radiating surface 2 was set to 1,560° C., 1,660° C., and 1,760° C.

To evaluate the surface flatness of the heat-treated substrate sample, the RMS values of the sample before and after heat-treating at each of the above-mentioned temperatures were measured within the measurement range of 4 μm×4 μm in the tapping mode of an AFM. Table 2 shows the measured RMS values. Note that the heat-treating temperature means the temperature of the substrate stage 1.

Each heat-treated sample underwent sacrificial oxidation and hydrofluoric acid cleaning to remove any surface deterioration layer. Further, silicon oxide patterning was performed, and then the SiC layer was etched to a diameter of 100 μm and a depth of 1 μm using an RIE (Reactive Ion Etching) device in an ambient of CF₄+Ar mixture gas to form a mesa.

20-nm thick titanium (Ti) and 100-nm thick aluminum (Al) were deposited on each sample using a vacuum deposition device, and each sample was heat-treated for 3 min at 900° C. in a heat-treating furnace in an argon (Ar) gas ambient to form an ohmic electrode.

To evaluate the obtained diode, its current density vs. voltage characteristics were measured using “Keithley 4200” at room temperature.

TABLE 2

Heat-treating Temperature

| | | | | Before |
|---|---|---|---|---|
| | | | | Heat- |
| | 1,450° C. | 1,550° C. | 1,650° C. | treating |
| RMS Value | 0.31 nm | 0.43 nm | 0.59 nm | 0.11 nm |

As can be seen from Table 2, the RMS value of each substrate sample even after heat-treating for 1 min at 1,650° C. was almost as small as that before heat-treating, and this means that the surface of each heat-treated substrate sample was very flat.

FIG. 8 shows the current density vs. voltage characteristics of the p⁺n diode at heat-treating temperatures of 1,450° C., 1,550° C., and 1,650° C.

At heat-treating temperatures of 1,450° C. and 1,550° C., high leakage current densities were measured at forward voltages of 0 V to 2 V. Again, at heat-treating temperatures of 1,450° C. and 1,550° C., high leakage current densities on the order of 10⁻⁴ A were measured in the reverse voltage range.

In contrast, at a heat-treating temperature of 1,650° C., almost no leakage current density was measured in the forward voltage range, and only a very low leakage current density on the order of 10⁻⁶ A was measured even in the reverse voltage range. This is supposedly because any crystal defects attributed to ion implantation into the pn junction interface disappeared by heat-treating at a temperature of 1,650° C.

In this manner, the use of the apparatus for heat-treating the substrate according to the present invention allows the fabrication of a p⁺n junction diode with a very good performance. Such pn junction is exploited not only for a pn junction diode but also for a field-effect transistor (MOS-FET), a junction transistor (J-FET), a MES-FET, and a bipolar transistor (BJT), and improves the characteristics of these electronic devices which uses SiC, leading to a significant improvement in productivity.

As described above, according to the present invention, it is possible to efficiently, uniformly heat a substrate at a high temperature within a short time, cool the substrate within a short time, and transport the substrate free from any damage inflicted on the robot arm, thus attaining a practical throughput even in an ultrahigh-temperature process.

Although preferred embodiments of the present invention have been described above with reference to the accompanying drawings, the present invention is not limited to these embodiments, and can be changed into various forms within the technical scope understood from a description of the scope of claims.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-049671, filed Mar. 3, 2009, which is hereby incorporated by reference herein in its entirety.

What is claimed is:

1. An apparatus for heat-treating a substrate, said apparatus comprising:
a substrate holder unit comprising a substrate stage which mounts a substrate and is made of one of carbon and a material coated with carbon;
a heating unit which is disposed above the substrate stage, has a heat radiating surface facing the substrate stage, and heats the substrate mounted on the substrate stage by radiant heat from the heat radiating surface while the heat radiating surface is not in contact with the substrate;
a chamber which accommodates the substrate holder unit and the heating unit; and
a lift device which lifts/lowers at least one of the substrate holder unit and the heating unit so that the substrate stage and the heat radiating surface of the heating unit come close to/separate from each other within the chamber,
wherein the substrate holder unit comprises:
a radiating plate which is disposed on a lower side of the substrate stage with a spacing therebetween, traps heat radiated by a lower surface of the substrate stage, and radiates the trapped heat to the substrate stage; and
a reflecting plate which is disposed on a lower side of said radiating plate with a spacing therebetween, and is made of one of a metal carbide, a metal nitride, a nickel alloy, and a nickel base superalloy.

2. The apparatus according to claim 1, wherein said reflecting plate is made of a metal carbide.

3. The apparatus according to claim 2, wherein the metal carbide includes a carbide of a refractory metal with a melting point of not less than 2,500° C.

4. The apparatus according to claim 3, wherein the metal carbide is one member selected from the group consisting of tantalum carbide (TaC), molybdenum carbide (MoC), and tungsten carbide (WC).

5. The apparatus according to claim 1, further comprising
a cooling panel which is disposed on a lower side of said reflecting plate with a spacing therebetween and cools at least one of said reflecting plate, said radiating plate, and the substrate stage.

6. The apparatus according to claim 5, wherein
the chamber comprises a first room and a second room which is located above said first room and communicates with said first room,
the heating unit is placed in said second room of the chamber such that the heat radiating surface faces down,
the substrate holder unit can lift/lower between said first room and said second room by an operation of the lift device, and
when the substrate holder unit lifts into said second room, the substrate stage and the heat radiating surface of the heating unit come close to each other and said cooling panel disables communication between said first room and said second room.

7. The apparatus according to claim 6, wherein
a plurality of pins configured to support the substrate stand upright in said first room of the chamber,
the substrate holder unit includes a plurality of through holes into which said plurality of pins can be vertically inserted, and
while the substrate holder unit is lowered from said second room to said first room, said plurality of pins extend above the substrate stage through said through holes and support the substrate mounted on the substrate stage.

8. A substrate manufacturing method comprising steps of:
mounting a substrate having an implantation region on a surface thereof on the substrate stage such that the surface of the substrate on a side of the implantation region faces the heat radiating surface of the heating unit; and
performing heat-treating of the mounted substrate using an apparatus for heat-treating a substrate defined in claim 1.

9. The method according to claim 8, wherein in the heat-treating, a cooling panel cools the substrate stage during heating of the substrate.
